(19) United States
(12) Patent Application Publication
(10) Pub. No.: US 2017/0241297 A1
(43) Pub. Date: Aug. 24, 2017

(54) WASTE THERMAL ENERGY RECOVERY DEVICE

(71) Applicant: Double Arrow Engineering, Center Point, TX (US)

(72) Inventor: Andrew R. Graczyk, Center Point, TX (US)

(21) Appl. No.: 15/440,326

(22) Filed: Feb. 23, 2017

Related U.S. Application Data
(60) Provisional application No. 62/389,289, filed on Feb. 23, 2016.

(51) Int. Cl. F01K 11/02; F01K 13/00

(52) U.S. Cl. CPC F01K 11/02; F01K 13/006; F16H 7/02

(57) ABSTRACT

A waste heat recovery system includes a condenser to receive a working fluid in a vapor state and provide the working fluid in a liquid state; a pump in fluid communication with the condenser; a waste heat boiler in fluid communication with the pump, the waste heat boiler to receive the working fluid from the pump and vaporize the working fluid using waste heat from a mechanical system; an expander in fluid communication with the waste heat boiler and the condenser, the expander to receive the vaporized working fluid from the waste heat boiler and to provide the working fluid to the condenser, the expander to produce mechanical power; and a mechanical coupling system mechanically coupled between the expander and the mechanical system.

### CROSS-REFERENCE TO RELATED APPLICATION(S)

This application claims benefit of U.S. Provisional Application No. 62/389,289, filed Feb. 23, 2016, which is incorporated herein by reference in its entirety.

### BACKGROUND

Gasoline internal combustion engines run at approximately 40% efficiency, while modern diesels run higher closer to 50% efficiency. In other words, only half or less of the stored chemical energy in the fuel is converted to useful mechanical work. The remainder is expelled as heat through the engine surface, the exhaust, or the radiator. Converting even 10% of the wasted energy into useful work can have huge positive impacts on efficiency. Utilizing waste heat recovery has been an item of interest for years, but few systems are commercially available other than stationary electricity generation.

There is a multitude of items available for increasing internal combustion engine efficiencies. An example is a turbocharger, which utilizes wasted energy in the form of kinetic energy of the moving exhaust gases to increase performance and efficiency. There are other devices that work to increase the efficiency, not by harnessing the wasted energy, but by increasing the thermodynamic efficiency of the process, such as cold-air-intakes. These types of devices work to increase the efficiency by reducing wasted energy. However, such devices do not reclaim wasted energy and cannot aid in bringing the whole system above the Carnot efficiency for the specific thermodynamic cycle (otto, diesel, etc).

There also exist several options for low-grade and high-grade waste heat to electricity power generators. These are large, stationary, and mechanically drive an electricity generator; they are not used to improve the efficiency of an engine, only of a building or a plant over all.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an example waste heat recovery system.

FIG. 2 and FIG. 3 include schematics of example waste heat recovery systems.

FIG. 4, FIG. 5, and FIG. 6 include flow diagrams illustrating example methods for operating a waste heat recovery system.

FIG. 7 and FIG. 8 include diagrams of an example expander for use in an example waste heat recovery system.

The use of the same reference symbols in different drawings indicates similar or identical items.

### DETAILED DESCRIPTION

In an example embodiment, a waste heat recovery system includes a condenser, a pump, a boiler, and an expander. Waste heat is transferred to a working fluid in the boiler to vaporize the working fluid, which is used by the expander to generate mechanical power. Downstream of the expander, the working fluid is condensed with the condenser, pressurized with the pump, sent back to the boiler. Mechanical power is transferred from the expander through a power transfer system to a mechanical system, such as the drive train of a vehicle or a drive shaft of an electric generator. In various examples, the waste heat recovery system further includes a controller to control system pressure, a rate of revolution of the expander, or the efficiency of the waste heat recovery system.

An energy conversion device or waste heat recovery system is used to convert heat energy into mechanical energy. This energy conversion device can be used in applications where energy is wasted in the form of heat, such as a with a large diesel truck. The wasted heat from the large truck engine can be extracted through the engine coolant or the exhaust in a two-stage system. For example, a working fluid can be preheated with coolant (stage 1) and boiled with exhaust (stage 2). The working fluid for the device can be a refrigerant (working fluid) selected specifically for the design conditions of the energy conversion device or waste heat recovery system. The heat can be transferred directly to the refrigerant through heat exchangers. The energy conversion device can utilize expansion of the working fluid to harness power and convert the power to mechanical work using a Rankin Cycle. The work can drive a power transfer device such as a viscous coupling or continuously variable transmission(CVT)/torque converter(TC) or a combination of a viscous coupling and said CVT/TC. The variable viscous coupling (VVC) is a mechanical coupling that has an input and an output, through which power is mechanically transferred by means of fluid viscosity, the magnitude of which is actively or passively adjustable thereby creating a variable level of engagement between the input and output. In an example, the power transfer device can be mechanically coupled to either the engine or the drive train of the vehicle, such as the driveshaft. The power transfer device is mechanically or electrically controlled and can adjust the ratio or magnitude of engagement automatically to provide a constant power or constant torque transfer. A constant torque power transfer device may also provide constant torque to the input of a constant power power transfer device. In another method, the energy conversion device is coupled to the engine or drivetrain via a viscous coupling alone, which can provide a constant torque transfer to the drivetrain rather than constant power. In an example, the viscous coupling is a variable viscous coupling. Such a method is a simple arrangement and can be more cost effective. An electromechanical clutch in conjunction with either the CVT/TC or variable viscous coupling can be utilized to decouple the device when mechanical load or rotational velocity are outside of the desired operating conditions.

The energy conversion device or waste heat recovery system can be controlled both electronically and mechanically. In an example, the controller senses the pressure and temperature in the boiler, determines the saturation pressure from the sensed temperature, and adjusts the supply pressure to match or slightly exceed the determined saturation pressure for the sensed temperature. Said boiler can have a mechanically or electrically controlled bypass to prevent overheating or over pressurizing the liquid. In an example, the pressure can be sensed on the liquid side of the system, just after the pump. In another example, pressure is measured after the boiler. The pressure can be adjusted via a controlled or static recirculating valve or by changing pump speed.

In another example, the rate of rotation of expander can be governed through the controller. The rate can be controlled by a control valve (throttle) at the exhaust side of the expander. The throttle valve restricts the exhaust flow, reducing the cylinder pressure ratio and thus, reducing the capacity. The controller actively senses the rate of rotation of the expander and controls accordingly. In an alternative example, the rate is controlled by controlling the load with a variable viscous coupling or the like. As the rate increases, the coupling permits less slip or a larger damping coefficient, providing more load on the expander and reducing the rate of rotation. As the rate of rotation decreases, the variable viscous coupling allows for more slip or smaller damping coefficient, providing less load on the expander. A third control method uses a combination of the throttle valve control and the mechanical load control, providing a preset low load during heat/ramp up with the variable viscous coupling while using the throttle valve to control rate of rotation, and once a preset temperature or pressure is reached in the boiler, fully opening the throttle, and using mechanical load for rate control. The waste heat recovery system can engage within a specific range of speed of the vehicle or rate of rotation of the drivetrain, or the system can engage throughout the entire range of speed or rate of rotation, providing a high amount of power or torque transfer.

In a further example, a mechanical or electric thermostatic valve on the condensing side of the system, downstream of the throttle valve and upstream of the pump, can maintain a constant condensing temperature even in colder weather.

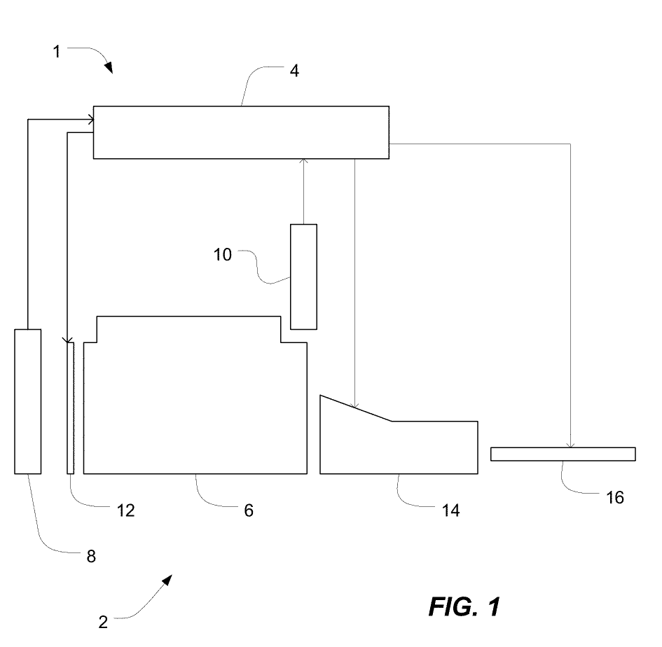

For example, FIG. 1 illustrates an example system 1 for recovering waste heat from a mechanical system, such as an engine, and using the waste heat to generate mechanical power to apply to the mechanical system, improving the efficiency of the system. The waste heat recovery system 4 can receive waste heat from an exhaust 10 or coolant system 8 of an engine 6 of the mechanical system 2. The waste heat recovery system 4 generates mechanical energy from the waste heat and transfers the mechanical energy to the mechanical system 2. For example, the mechanical energy can be provided to a belt 12, a transmission 14, or a drive train 16 of the mechanical system 2. In another example, the mechanical energy can be provided to a crankshaft of an engine 6 of the mechanical system 2.

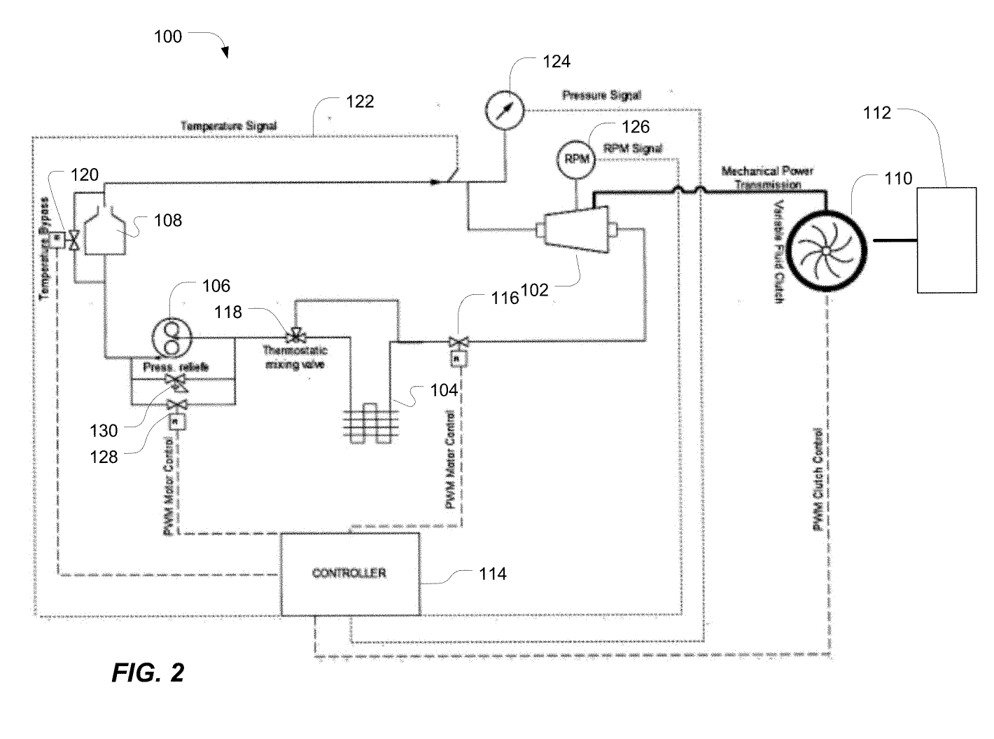

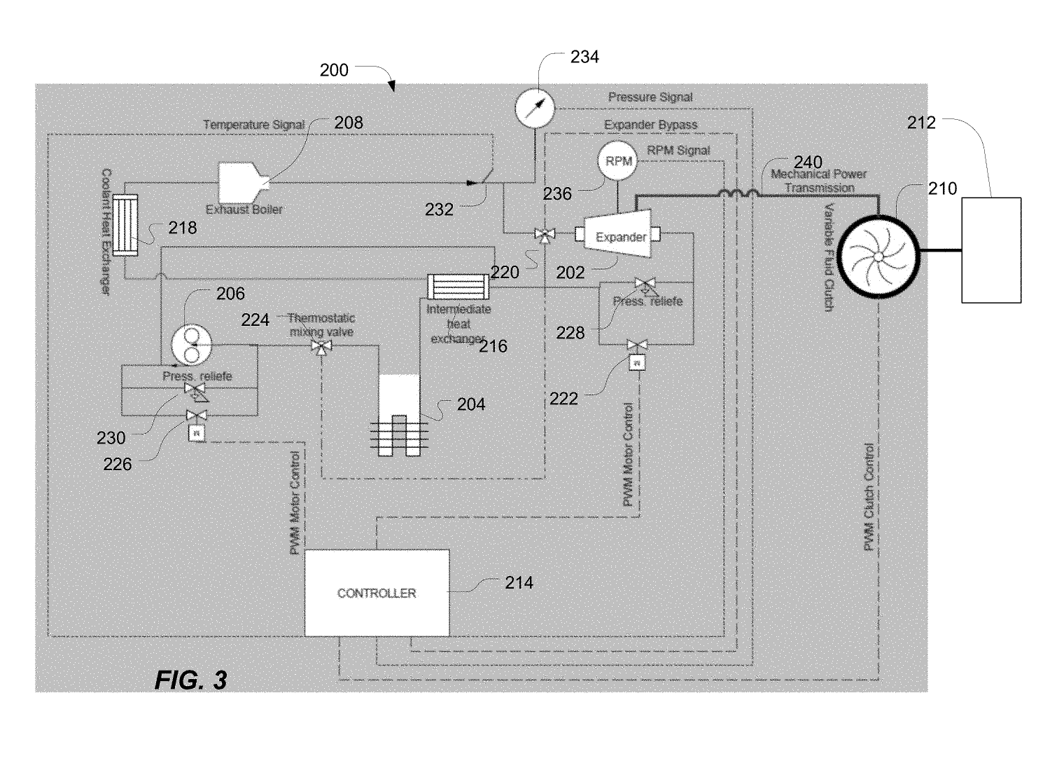

As illustrated in FIG. 2, a system 100 includes an expander 102, a condenser 104, a pump or compressor 106, and boiler 108. A working fluid is boiled or evaporated in the boiler 108 and directed to the expander 102 to expand, drawing energy from the working fluid and converting the energy to mechanical energy. The working fluid is returned to the boiler 108 via a condenser 104 and pump or compressor 106. The mechanical energy generated by the expander 102 can be transferred through mechanical transmission 132 to a power transfer system 110 coupled to a mechanical system 112, such as a motor, transmission, or drivetrain of a vehicle or other mechanical device. In particular, the boiler can recovery waste heat from the vehicle or other mechanical device and generate mechanical energy through the expander 102. As such, the system can utilize waste heat to improve the efficiency of a mechanical system 112, such as a vehicle or other mechanical device.

The working fluid can be a coolant or a refrigerant. In an example, the working fluid is an aqueous working fluid. In another example, the working fluid is a refrigerant, such as a fluorocarbon or chlorofluorocarbon refrigerant. For example, the working fluid can be 2,3,3,3-tetrafluoropropene (HFO-1234yf), 1,3,3,3-tetrafluoropropene (HFO-1234ze), or 1-chloro-3,3,3-trifluoropropene (HFO-1233zd). In an example, the working fluid is HFO-1233zd.

In an example, the expander 102 can be a turbine or a piston expander system. In a particular example, the expander 102 is a piston expander system, such as an axial piston expander.

In an example, the condenser 104 is an air-cooled heat exchanger. For example, the condenser 104 can be a finned heat exchanger for transferring heat from a working fluid to air.

The pump 106 can be a geared pump, a screw pump, or a piston pump. In an example, the pump 106 can be controlled to vary a discharge pressure. Alternatively, the pump 106 can run at a set rate and discharge pressure can be controlled with a backflow valve 128.

The boiler 108 can extract waste heat from an exhaust of an engine or the engine itself, or other cooling fluids associated with the engine. The nature of the boiler 108 can be arranged based on the fluid or structure from which the waste heat is derived.

The waste heat recovery system 100 can also include a controller 114 to control various aspects of the system, such as a pressure entering the expander, a back pressure applied to the expander 102, a rate of rotation of the expander 102, or load applied by the power transfer system 110. For example, a temperature signal 122 and a pressure signal 124 can be measured prior to the working fluid entering the expander 102. The temperature signal 122 and the pressure signal 124 can be utilized by the controller 114 to control an optional bypass valve 120 around the boiler 108 or a backflow valve 128 circulating working fluid around the pump 106. In particular, the controller 114 can determine based on the temperature signal 122 or the pressure signal 124, a saturation level or level of superheating of the working fluid and manipulate the valves 120 or 128 to achieve a desired saturation level or level of superheating of the working fluid prior to the working fluid entering the expander 102.

In a further example, the controller 114 can be used to control a rate of rotation of the expander 102. For example, the controller 114 can measure a rate per minute (RPM) signal 126 associated with the expander 102. The controller 114 can use the RPM signal 126 to control a backpressure valve 116, which applies back pressure to the expander 102, limiting the pressure ratio across the expander 102 and reducing the rate of rotation. Alternatively, the backpressure valve 116 can open allowing an increased ratio of pressure and thus, increase the rate of rotation of the expander 102. In a further example, the system can use the controller 114 to control the power transfer system 110, which influences the rate of rotation measured by the RPM signal 126.

In an example, the control valves 116, 128, or 120 are pneumatically controlled or electrically controlled. For example, the control valves 116, 128 or 120 can be electrically controlled.

Optionally, a mechanical or electrical thermostatic mixing valve 118 can be disposed downstream of the condenser 104 and draw working fluid upstream of the condenser 104. Such a thermostatic mixing valve 118 can be useful in maintaining a desired level of cooling, particularly in cold weather situations. While it is desirable for the working fluid to be in a condensed liquid state, is preferable for the liquid working fluid to be at a temperature closer to its boiling point when it reaches the boiler 108.

The power transfer system 110 can coupled to the vehicle or other mechanical system 112 to provide mechanical torque or power to the vehicle or other mechanical system 112. For example, the power transfer system 110 can mechanically couple to an engine, such as through a drive belt, a transmission of the vehicle, a drivetrain or shaft of the vehicle, or a crankshaft of an engine of the vehicle. For example, providing a direct mechanical coupling between the expander 102 and the mechanical systems 112 associated with the engine, transmission, or drivetrain, increases the efficiencies of the mechanical system 112. The power transfer system 110 can include a variable fluid clutch or variable viscous coupling, continuous variable transmission, or torque converter. In an example, the power transfer system 110 includes a variable viscous coupling (VVC). The variable viscous coupling (VVC) is a mechanical coupling that has an input and an output, wherein power is mechanically transferred by means of fluid viscosity, the magnitude of which is actively or passively adjustable, thereby creating a variable level of engagement between the input and output. The power transfer system 110 can optionally include an electromechanical clutch in conjunction with other mechanisms to decouple the system when demands of the system exceed or are outside the range of an operating condition, such as a RPM threshold.

FIG. 3 illustrates an alternative system 200 including an expander 202, a condenser 204, a pump 206, and a boiler 208. In an example, the expander 202 can be a turbine or a piston expander system. In a particular example, the expander 202 is a piston expander system, such as an axial piston expander. In an example, the condenser 204 is an air-cooled heat exchanger. For example, the condenser 204 can be a finned heat exchanger for transferring heat from a working fluid to air. The pump 206 can be a geared pump, a screw pump, or a piston pump. In an example, the pump 206 can be controlled to vary a discharge pressure. Alternatively, the pump 206 can run at a set rate, and discharge pressure can be controlled with a backflow valve 226. The boiler 208 can extract waste heat from an exhaust of an engine or the engine itself, or other cooling fluids associated with the engine. The nature of the boiler 208 can be arranged based on the fluid or structure from which the waste heat is derived.

The boiler 208 can draw heat from an engine exhaust to boil the working fluid. Optionally, the system 200 can also include a coolant heat exchanger 218 to draw heat from a coolant system associated with an engine. The coolant heat exchanger 218 can be positioned upstream of the exhaust boiler 208 and can preheat the working fluid prior to the exhaust boiler 208.

In a further example, the system can include a heat exchanger 216 to cool the working fluid before it enters the condenser 204 using the liquid working fluid exiting the pump 206 prior to the liquid working fluid entering the coolant heat exchanger 218 or the exhaust boiler 208. In an example, the coolant heat exchanger 218 or the heat exchanger 216 can be a shell and tube heat exchanger.

As a precaution, to prevent overpressure situations, the system can include a pressure relief valve 230 disposed around the pump 206 or a pressure relief valve 228 downstream of the expander 202.

As above, the expander 202 generates mechanical power that is transmitted through the mechanical power transmission 240 to the power transfer system 210 mechanically coupled to a mechanical system 212 such as an engine, crankshaft, drivetrain, or transmission. The power transfer system 210 can include a variable fluid clutch or variable viscous coupling, continuous variable transmission, or torque converter. The power transfer system 210 can optionally include an electromechanical clutch in conjunction with other mechanisms to decouple the system when demands of the system exceed or are outside the range of an operating condition, such as a RPM threshold.

In an example, a controller 214 can measure the temperature upstream of the boiler to provide a temperature signal 232 and a pressure upstream of the boiler to provide a pressure signal 234, as well as the rate of rotation of the expander 202 through the RPM signal 236. Optionally or alternatively, the pressure can be measured after the pump 206 and downstream of the boiler 208. Using these measurements, the controller 214 can control the pump backflow valve 226, the backpressure or throttle valve 222 downstream of the expander, the power transfer system 210, and an expander bypass valve 220. For example, the controller 214, utilizing the temperature signal 232 and the pressure signal 234 can determine a saturation level of the vaporized working fluid leaving the boiler 208 and entering the expander 202. The controller 214 can manipulate the pressure leaving the pump by opening or closing the pump backflow valve 226.

The controller 214 can also control a rate of rotation of the expander, utilizing either a change in pressure ratio across the expander 202 by opening or closing the back pressure or throttle valve 222 or by altering the mechanical load applied to the expander 222 by manipulating the power transfer system 210. Further, the controller 214 can bypass either completely or partially the expander 202 by opening or closing the expander bypass valve 220, for example, when the system has yet to reach operating conditions suitable for the expander 202 during startup or to take the expander 202 off-line.

In a further example, the system 200 can include a thermostatic mixing valve 224 to partially or completely bypass the condenser 204, for example, during cold weather conditions to maintain a desired temperature of the condensed working fluid.

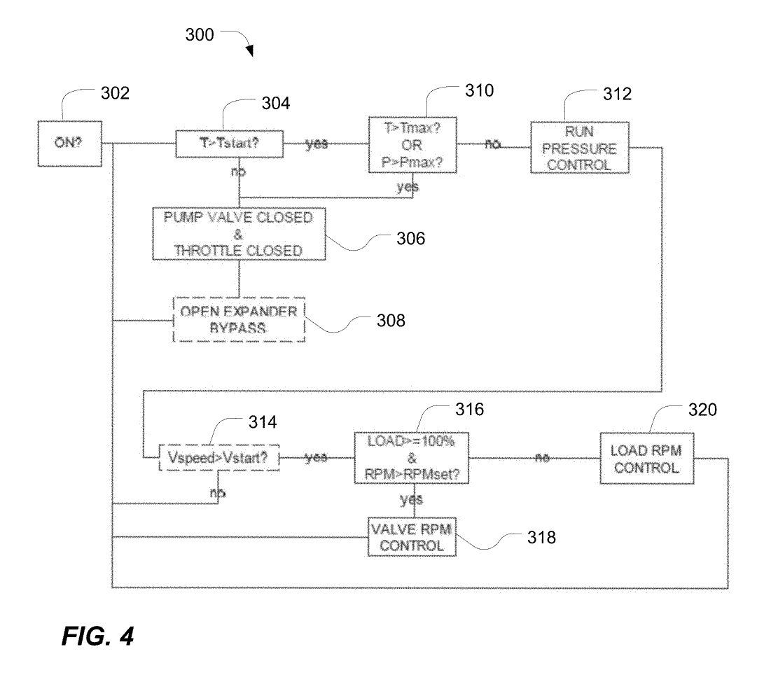

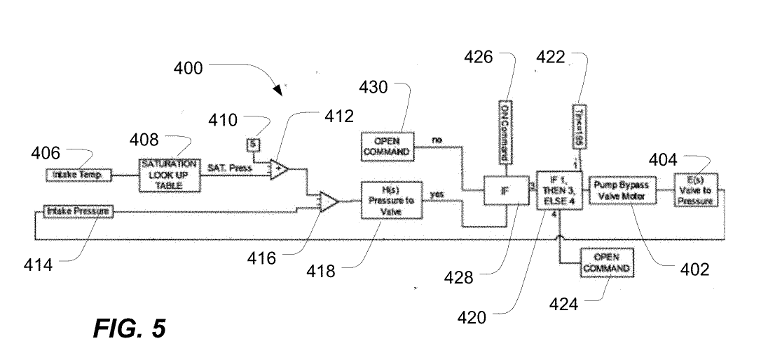

FIG. 4 illustrates an operating method 300. When the system is turned on, as illustrated at block 302, the system checks to determine whether the temperature is greater than a desired starting temperature, as illustrated at block 304. When the temperature does not exceed the desired start temperature, the pump valve and the throttle valve are closed, as illustrated at block 306. Optionally, the expander bypass valve is opened, as illustrated at block 308.

When the temperature of the fluid leaving the boiler exceeds the desired start temperature, the system determines whether the temperature is greater than a threshold temperature, such as a maximum operating temperature, or whether the pressure is greater than a threshold pressure, such as a maximum operating pressure, as illustrated at block 310. When the temperature exceeds a threshold temperature or the pressure exceeds the threshold pressure, the pump valve can be closed and the throttle valve can be closed, as illustrated at block 306, and the expander bypass valve can be opened, as illustrated at 308.

When the temperature is greater than the desired start temperature and less than a threshold temperature and the pressure is less than the threshold pressure, the system can run pressure control, as illustrated at block 312. For example, the pump or the pump bypass valve can be used to adjust the pressure to maintain a desired level of saturation or level of superheating (e.g., pressure below the saturation pressure or temperature above a condensation temperature) of the vaporized working fluid entering the expander.

Optionally, as illustrated at block 314, the system can test to determine whether the rotational velocity of the expander or a rotational velocity of the mechanical load is greater than a threshold start speed. When the system speed is greater than the threshold start speed, the system can test to determine whether the load is greater than equal to a threshold load, such as a desired operating load, and whether the rotational velocity of the expander is greater than a threshold rotational velocity. When the load is high and the rate is greater than a threshold rate, the system can use valve control to control the rate of rotation of the expander, as illustrated at block 318. For example, a backpressure or throttle valve can be utilized to alter a pressure ratio across the expander, changing the rate of revolution of the expander.

When the load has not exceeded a desired maximum and the rate is not greater than a set rate, load control can be used, as illustrated in block 320, by adjusting the power transfer system. For example, load control can be achieved by manipulating the variable viscosity coupling, connecting or disconnecting a clutch, or changing a gearing ratio. In this manner, the expander can be controlled using different schemes under different conditions.

FIG. 5 illustrates a further control method 400 for controlling a pressure of the system. For example, a pump bypass valve motor 402 controls the position of the pump bypass valve and thus, the intake pressure 414 downstream of the boiler and at the intake of the expander. The influence of the pump bypass valve position on the intake pressure 414 of the expander is represented by a transfer function at block 404. Expander intake temperature 406 is measured and compared to a saturation lookup table 408 to determine a saturation pressure 408, the value of which is adjusted by a constant 410 at block 412. The adjusted saturation pressure is compared to the intake pressure 414 at block 416, providing a signal indicating a deviation of the intake pressure 414 from a desired pressure indicated by block 412. The deviation signal is used as input for controlling the pump or pump bypass valve.

When an intake temperature at block 422 is greater than a set start temperature, the system can open the pump bypass valve. When the intake temperature at block 422 is less than the set start temperature, the system can determine whether a command to start the system (“ON Command”) has been received, as illustrated at block 428. When the On Command has not been received, the system can open the bypass valve. When the On Command has been received, the system can function to control the bypass valve based on the deviation signal, as indicated by the transfer function illustrated in block 418.

In FIG. 6, a further control method 500 for controlling an expander is illustrated. The exhaust valve motor illustrated at block 502 can control a position of the backpressure or throttle valve downstream from the expander. A transfer function illustrated at block 504 represents the influence of the throttle valve position on an RPM signal at block 506 measured based on the expander's rate of rotation. The RPM signal at block 506 can be compared to a set point (block 508) at block 510 to provide a signal indicating a deviation of the RPM signal from a set point. As illustrated at block 512, depending on whether the backpressure or throttle valve is fully open, as illustrated at 514, which is to occur at a select design RPM, the deviation signal is used to either control the power transfer system, represented by a transfer function 516, or the backpressure or throttle valve, represented by block 518.

Turning to block 520, when intake temperature to the expander is below a threshold temperature, such as a maximum operating temperature, as illustrated at block 522, the system at block 526 determines whether a start or “ON” command has been received (block 528). When the ON command has been received, they system can direct control of the backpressure or throttle valve based on the deviation signal, as represented by the transfer function illustrated in block 518. Control of the backpressure or throttle valve can result in valve becoming fully open, feeding back into block 514. Alternatively, when the ON command has not been received, the system can close the backpressure valve, as illustrated at block 530.

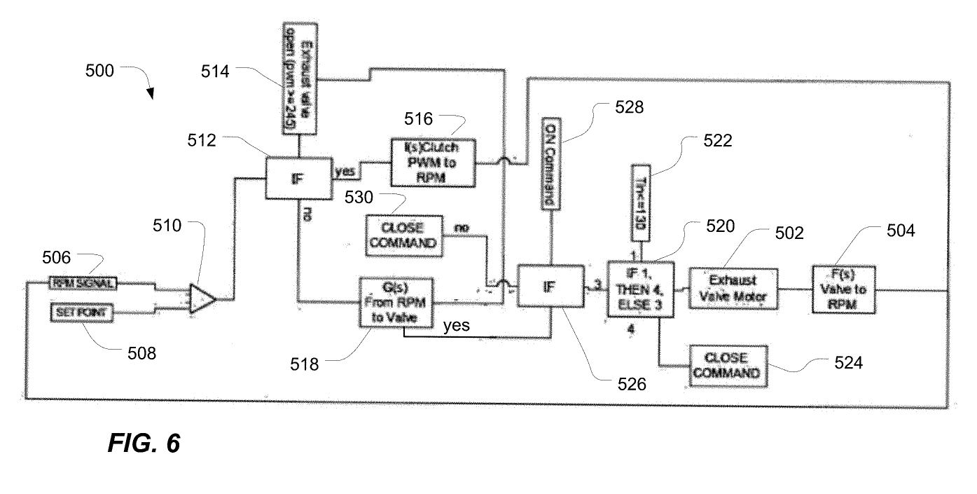

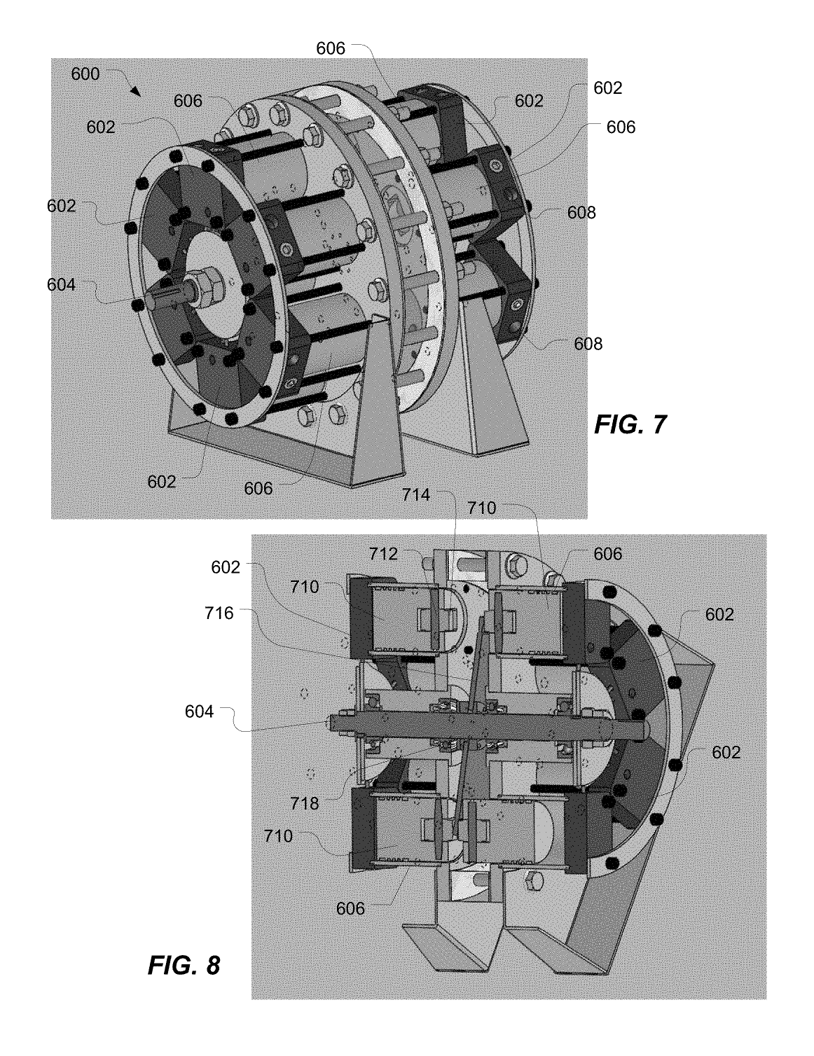

FIG. 7 and FIG. 8 include illustrations of an example expander 600. In an example, the expander 600 can have an axial design, which can reduce bearing friction and footprint. A set of cylinders 606 surround a central shaft 604. A first set of cylinders can be disposed at one end of the shaft 604 and an opposing set of cylinders can be disposed at an opposite end of the shaft 604. Thus, the number of cylinders can be doubled. Each cylinder 606 includes manifold 602 including intake and exhaust valves (e.g., valve 608). The valves can be cam driven mechanical poppet valves or gate valves or can be electronically driven poppet valves. As illustrated in FIG. 7, a swashplate 716 can be coupled to the shaft 604 using coupling 718. During rotation, swashplate 716 moves from high to low positions allowing a reciprocating action among the pistons 710, allowing working fluid in the cylinders 606 to expand and pressurize. The swashplate 716 can utilize a rolling element or solid bearings. Alternatively, each piston 710 can include a connector 712 securing a rolling element 714. One piston is illustrated is not being connected to the swashplate 716 to permit illustration of the rolling element. The piston 710 includes a roller 714 that is to contact the swashplate 716 during operation, allowing the swashplate 716 to rotate between the pistons and move the pistons by the nature of the tilt relative to the shaft 604.

The heads and pistons can be a plastic material to reduce both heat transfer and reciprocating mass. The pressure ratio of the cylinder/piston systems can be designed for the specific conditions and the specific working fluid selected. The working fluid temperatures can be low enough to allow for usage of plastics in areas of the system. The low-pressure side of the working fluid can have a means to equalize pressure within an enclosed and sealed volume in which the swashplate is contained, providing a means for reclaiming working fluid that leaks past the reciprocating seals. Dry running rotary seals and sealed or solid bearings can be within this sealed area.

The waste heat recovery system can not only recover wasted energy, but turn the waste energy into mechanical energy that is directly useful without user input and without any additional conversion processes, such as electrical generation, increasing the efficiency of the waste heat recovery system. Such a system can provide a decrease in fuel consumption on an internal combustion engine. Engines incorporating this waste heat recovery system can achieve above the maximum thermodynamic efficiency of an internal combustion when calculated as a whole system. The waste heat recovery system can be beneficial on large diesel engines, both stationary and mobile, such as large trucks. The system can also be used on stationary diesel generators, pumps, or other stationary internal combustion engine systems. The system can be designed such that it can be implemented in an after-market application. The waste heat recovery system provides no extra burden on the end user and utilizes little maintenance.

In a first aspect, a waste heat recovery system includes a condenser to receive a working fluid in a vapor state and provide the working fluid in a liquid state; a pump in fluid communication with the condenser to receive the working fluid in the liquid state and to increase a pressure of the working fluid; a waste heat boiler in fluid communication with the pump, the waste heat boiler to receive the working fluid from the pump and vaporize the working fluid using waste heat from a mechanical system; an expander in fluid communication with the waste heat boiler and the condenser, the expander to receive the vaporized working fluid from the waste heat boiler and to provide the working fluid to the condenser, the expander to produce mechanical power; a mechanical coupling system mechanically coupled between the expander and the mechanical system; a pump bypass valve to receive working fluid downstream of the pump and to provide working fluid upstream of the pump; and a controller to control the pump bypass valve based on a saturation level of the vaporized working fluid upstream of the waste heat boiler.

In a second aspect, a waste heat recovery system includes a condenser to receive a working fluid in a vapor state and provide the working fluid in a liquid state; a pump in fluid communication with the condenser to receive the working fluid in the liquid state and to increase a pressure of the working fluid; a waste heat boiler in fluid communication with the pump, the waste heat boiler to receive the working fluid from the pump and vaporize the working fluid using waste heat from a mechanical system; an expander in fluid communication with the waste heat boiler and the condenser, the expander to receive the vaporized working fluid from the waste heat boiler and to provide the working fluid to the condenser, the expander to produce mechanical power; a mechanical coupling system mechanically coupled between the expander and the mechanical system, the mechanical coupling system including a controllable coupling controllable to vary a mechanical load on the expander; a throttle valve disposed downstream of the expander; and a controller to selectively control the throttle valve or the controllable coupling based on a rate of revolution of the expander.

In a third aspect, a method for controlling a waste heat recovery system includes detecting a mechanical load applied to an expander by a mechanical system mechanically coupled to the expander through a power transfer system; detecting a rate of revolution of the expander; and selectively controlling the rate of revolution either by controlling a throttle valve downstream of the expander to apply backpressure or by controlling the power transfer system to adjust the mechanical load.

In a fourth aspect, a method for controlling a waste heat recovery system includes detecting a temperature and a pressure of a working fluid upstream of a waste heat boiler and downstream of an expander; determining a saturation pressure of the working fluid based on the temperature of the working fluid; comparing the saturation pressure to the pressure of the working fluid; and controlling the pressure of the working fluid upstream of a pump.

In an example of the above aspects and examples, the saturation is determined using a lookup table and a temperature upstream of the waste heat boiler to determine a saturation pressure and comparing the saturation pressure to a pressure of the working fluid upstream of the waste heat boiler.

In another example of the above aspects and examples, the mechanical coupling system comprises a variable viscous coupling.

In a further example of the above aspects and examples, the mechanical coupling system further comprises a clutch.

In an additional example of the above aspects and examples, the mechanical coupling system further comprises a continuous variable transmission.

In another example of the above aspects and examples, the mechanical coupling system further comprises a torque converter.

In a further example of the above aspects and examples, the mechanical coupling system is mechanically coupled to a drivetrain of the mechanical system.

In an additional example of the above aspects and examples, the mechanical coupling system is mechanically coupled to a transmission of the mechanical system.

In a further example of the above aspects and examples, the mechanical coupling system is mechanically coupled to a belt of an engine of the mechanical system.

In another example of the above aspects and examples, the mechanical coupling system is mechanically coupled to a crankshaft of an engine of the mechanical system.

In a further example of the above aspects and examples, the pump is driven by a belt of an engine of the mechanical system.

In an additional example of the above aspects and examples, the pump is driven through a mechanical coupling to the expander.

In another example of the above aspects and examples, the system further includes a mixing valve to receive working fluid upstream of the condenser and to add working fluid downstream of the condenser and upstream of the pump.

In a further example of the above aspects and examples, the system further includes a heat exchanger to exchange heat from the working fluid upstream of the condenser with the working fluid downstream of the pump.

In an additional example of the above aspects and examples, the system further includes a coolant heat exchanger disposed in line between the pump and the waste heat boiler, the coolant heat exchanger to heat the working fluid using heat from a coolant of an engine of the mechanical system.

In another example of the above aspects and examples, the system further includes a bypass line and bypass valve disposed to allow working fluid to bypass the waste heat boiler. For example, the controller is to open and close the bypass valve based on a temperature of the working fluid upstream of the waste heat boiler.

In a further example of the above aspects and examples, the system further includes an expander bypass to allow working fluid to bypass the expander. For example, the controller is to open the expander bypass when a temperature of the working fluid upstream of the waste heat boiler does not meet a threshold.

In an additional example of the above aspects and examples, the working fluid comprises HFO-1233zd.

In another example of the above aspects and examples, the working fluid enters the expander in a super critical state.

In an example of the above aspects and examples, the working fluid enters the expander in a super critical state.

In another example of the above aspects and examples, controlling the pressure includes adjusting a rate of the pump.

In a further example of the above aspects and examples, controlling the pressure includes controlling a backflow valve around the pump.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A waste heat recovery system comprising:
a condenser to receive a working fluid in a vapor state and provide the working fluid in a liquid state;
a pump in fluid communication with the condenser to receive the working fluid in the liquid state and to increase a pressure of the working fluid;
a waste heat boiler in fluid communication with the pump, the waste heat boiler to receive the working fluid from the pump and vaporize the working fluid using waste heat from a mechanical system;
an expander in fluid communication with the waste heat boiler and the condenser, the expander to receive the vaporized working fluid from the waste heat boiler and to provide the working fluid to the condenser, the expander to produce mechanical power;
a mechanical coupling system mechanically coupled between the expander and the mechanical system;
a pump bypass valve to receive working fluid downstream of the pump and to provide working fluid upstream of the pump; and
a controller to control the pump bypass valve based on a saturation level of the vaporized working fluid upstream of the waste heat boiler.

2. The waste heat recovery system of claim 1, wherein the saturation is determined using a lookup table and a temperature upstream of the waste heat boiler to determine a saturation pressure and comparing the saturation pressure to a pressure of the working fluid upstream of the waste heat boiler.

3. The waste heat recovery system of claim 1, wherein the mechanical coupling system comprises a variable viscous coupling.

4. The waste heat recovery system of claim 1, wherein the mechanical coupling system further comprises a clutch.

5. The waste heat recovery system of claim 1, wherein the mechanical coupling system further comprises a continuous variable transmission.

6. The waste heat recovery system of claim 1, wherein the mechanical coupling system further comprises a torque converter.

7. The waste heat recovery system of claim 1, wherein the mechanical coupling system is mechanically coupled to a drivetrain of the mechanical system.

8. The waste heat recovery system of claim 1, wherein the mechanical coupling system is mechanically coupled to a transmission of the mechanical system.

9. The waste heat recovery system of claim 1, wherein the mechanical coupling system is mechanically coupled to a belt of an engine of the mechanical system.

10. The waste heat recovery system of claim 1, wherein the mechanical coupling system is mechanically coupled to a crankshaft of an engine of the mechanical system.

11. The waste heat recovery system of claim 1, wherein the pump is driven by a belt of an engine of the mechanical system.

12. The waste heat recovery system of claim 1, wherein the pump is driven through a mechanical coupling to the expander.

13. The waste heat recovery system of claim 1, further comprising a mixing valve to receive working fluid upstream of the condenser and to add working fluid downstream of the condenser and upstream of the pump.

14. The waste heat recovery system of claim 1, further comprising a heat exchanger to exchange heat from the working fluid upstream of the condenser with the working fluid downstream of the pump.

15. The waste heat recovery system of claim 1, further comprising a coolant heat exchanger disposed in line between the pump and the waste heat boiler, the coolant heat exchanger to heat the working fluid using heat from a coolant of an engine of the mechanical system.

16. The waste heat recovery system of claim 1, further comprising a bypass line and bypass valve disposed to allow working fluid to bypass the waste heat boiler.

17. The waste heat recovery system of claim 16, wherein the controller is to open and close the bypass valve based on a temperature of the working fluid upstream of the waste heat boiler.

18. The waste heat recovery system of claim 1, further comprising an expander bypass to allow working fluid to bypass the expander.

19. The waste heat recovery system of claim 18, wherein the controller is to open the expander bypass when a temperature of the working fluid upstream of the waste heat boiler does not meet a threshold.

20. The waste heat recovery system of claim 1, wherein the working fluid comprises HFO-1233zd.

21.-27 (canceled)
